(19) United States
(12) Patent Application Publication
(10) Pub. No.: US 2005/0086001 A1
(43) Pub. Date: Apr. 21, 2005

(54) System and method for assigning pseudo random noise codes to pseudo satellites

(75) Inventors: Hee-Jung Kim, Seoul (KR); Eun-Tae Won, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/890,788

(22) Filed: Jul. 14, 2004

(30) Foreign Application Priority Data
Aug. 14, 2003 (KR) P2003-56601

(51) Int. Cl. G01C 21/26

(52) U.S. Cl. 701/213

(57) ABSTRACT

A pseudolite PRN code assigning system and method are provided. In the system, a management server collects information related to PRN codes of GPS satellites, and a plurality of pseudolites (pseudo satellites) modulate transmission signals with PRN codes assigned from the management server.

### PRIORITY

This application claims priority under 35 U.S.C. § 119 to an application entitled “System and Method for Assigning Pseudo Random Noise Codes to Pseudo Satellites” filed in the Korean Intellectual Property Office on Aug. 14, 2003 and assigned Serial No. 2003-56601, the contents of which are incorporated herein by reference.

### BACKGROUND OF THE INVENTION

1. Field of the Invention

The present invention relates generally to a system and method for assigning PRN (Pseudo Random Noise) codes to pseudo satellites, and in particular, to a system and method for assigning PRN codes to pseudo satellites using data obtained from visible satellite observations at a specific time or position.

2. Description of the Related Art

Systems for determining the position of a person or object using GPS (Global Positioning System) satellites have recently attracted rapidly increasing attention. One system in particular, is in the automobile sector where companies are offering GPS satellite-based navigation services.

A GPS receiver determines its location by calculating its distance from at least two GPS satellites using signals received from the GPS satellites. Though the GPS receiver can calculate its location in different ways, it usually does so by receiving signals from at least four or five GPS satellites.

A GPS receiver can receive more signals from GPS satellites in a park or in the suburbs, than it can in an area obstructed by buildings in dense urban areas. The urban obstructions often make it impossible for the GPS receiver to see a sufficient number of GPS satellites to accurately determine the position. The GPS receiver may not observe a minimum number of GPS satellites required to calculate its location. Also, when a GPS receiver is used indoors, it cannot receive enough GPS satellite signals and, as such, GPS satellite-based positioning is unavailable.

In an attempt to overcome these problems, GPS pseudolites (shortened form of pseudo satellites) are generally deployed. A pseudolite is a ground based transmitter that transmits a signal similar to that of an actual GPS satellite. This provides a ground GPS receiver with GPS positioning information in an area where a GPS signal is unavailable.

GPS satellites modulate their GPS signals with a specific PRN code prior to transmission, so that the GPS receiver can identify the GPS satellites from the GPS signals received.

To enable the GPS receiver to discriminate between signals from pseudolites, as those from GPS satellites, unique PRN codes must also be assigned to the pseudolites.

ICD-GPS-200 (an interface standard between a GPS satellite and a GPS receiver as established by the American ARNIC Research Institute) designated 36 available PRN codes and numbered them from 1 through 37. PRN codes #34 and #37 are identical. 32 PRN codes, PRN #1 through PRN #32 are assigned to GPS satellites, and the remaining codes are reserved for other purposes such as pseudolites.

Conventionally, the reserved PRN codes PRN #33 through PRN #36 (excluding PRN #37 because it is identical to PRN #34) are available to pseudolites. Also if a pseudolite itself contains a GPS receiver, the pseudolite uses a PRN code corresponding to the PRN code of a GPS satellite from which it cannot receive a signal.

FIG. 1 is a schematic block diagram of a conventional pseudolite. Referring to FIG. 1, a pseudolite 10 comprises a GPS receiver 12 and a pseudolite controller 14. The pseudolite controller 14 analyzes the GPS signals received from the GPS receiver 12, selects a PRN code of a GPS satellite whose signal is not received, and uses that PRN code as the PRN code of the pseudolite 10. That is, the pseudolite 10 modulates a transmission signal with a PRN code corresponding to the PRN number of the GPS receiver from which the GPS receiver 12 cannot receive a signal.

The above conventional pseudolite PRN code assignment exhibits the following shortcomings.

The use of PRN codes PRN #33 through PRN #36 for pseudolites works well if only a limited number of pseudolites are disposed in a small area. In longer areas there is a lack of PRN codes for deployment of many pseudolites. For accurate positioning calculations more than four PRN codes are needed in a large area where more than four pseudolites are needed. As a general limitation, one pseudolite should not use the same PRN code as another pseudolite within the same coverage area.

In the case where a pseudolite equipped with a GPS receiver autonomously selects its PRN code, that the situation may occur where two pseudolites within the same coverage area select the same PRN code.

### SUMMARY OF THE INVENTION

An object of the present invention is, therefore, to provide a pseudolite PRN code assigning system and method that can compensate for a lack of PRN codes even if the pseudolites are disposed over a large area.

Another object of the present invention is to provide a pseudolite PRN code assigning system and method for preventing an identical PRN code from being selected by two pseudolites within the same coverage area.

A further object of the present invention is to provide a pseudolite PRN code assigning system and method in which a control center having PRN code assignment information manages the PRN codes of pseudolites within a predetermined distance from the control center.

Still another object of the present invention is to provide a pseudolite PRN code assigning system and method for classifying PRN codes as PRN codes available for pseudolites based on time-based visible satellite information and assigning the available PRN codes to the pseudolites on a time basis.

The above objects are achieved by a system and method for assigning PRN codes to pseudolites.

According to one aspect of the present invention, in a pseudolite PRN code assigning method for a management server having a GPS receiver and managing the PRN codes of pseudolites within a predetermined range, information about the PRN codes of GPS satellites is collected, a prestored PRN code management list using the collected PRN code information is verified and updated, a PRN code to be assigned to a pseudolite requesting a new PRN code is determined referring to the PRN code management list, and the determined PRN code is notified to the pseudolite.

According to another aspect of the present invention, in a pseudolite PRN code assigning method for a management server having a GPS receiver and managing the PRN codes of pseudolites within a predetermined range, visible satellite information is collected every unit time for a predetermined observation period, a time-based pseudolite PRN code assignment table is made using the collected visible satellite information, PRN codes to be assigned to the pseudolites are determined referring to the PRN code assignment list, and the determined PRN codes are notifies to the pseudolites.

According to a further aspect of the present invention, in a pseudolite PRN code assigning system, a management server collects information about the PRN codes of GPS satellites, and a plurality of pseudolites modulate transmission signals with PRN codes assigned from the management server.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a conventional pseudolite;

FIG. 2 is a block diagram illustrating the configuration of a pseudolite PRN code assigning system according to an embodiment of the present invention;

FIG. 3 is a block diagram of a control center according to the embodiment of the present invention;

FIGS. 4A and 4B are block diagrams of pseudolites to which PRN codes are assigned according to the embodiment of the present invention;

FIG. 5 is a flowchart illustrating a pseudolite PRN code assigning method according to the embodiment of the present invention;

FIG. 6 is an example of a table listing the use states of pseudolite PRN codes for the pseudolite PRN code assigning method according to the embodiment of the present invention;

FIG. 7 is a flowchart illustrating a pseudolite PRN code assigning method according to another embodiment of the present invention;

FIG. 8 is a graph illustrating the states of visible satellites by time at a specific position;

FIG. 9 is an example of a table listing the use states of pseudolite PRN codes by time in the pseudolite PRN code assigning method according to the second embodiment of the present invention;

FIGS. 10A, 10B and 10C illustrate an example grouping of a plurality of pseudolites for management;

FIG. 11 is an example of a table listing the use states of pseudolite PRN codes by time/group in a pseudolite PRN code assigning method according to a third embodiment of the present invention;

FIG. 12 is an example of a table listing assigned pseudolite PRN codes by time/group in the pseudolite PRN code assigning method according to the third embodiment of the present invention; and

FIGS. 13A and 13B illustrate arrays of pseudolites according to the present invention.

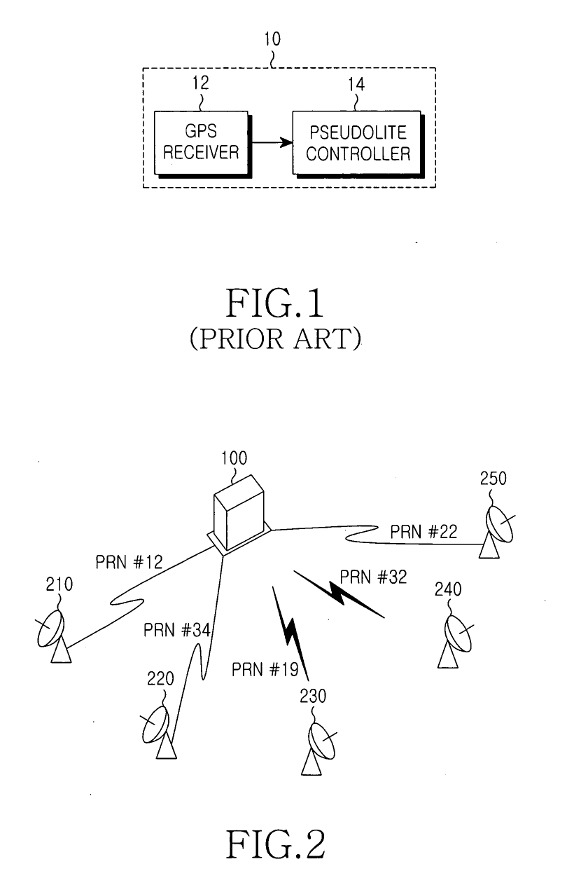

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

FIG. 2 is a schematic block diagram of a pseudolite PRN code assigning system according to an embodiment of the present invention. Referring to FIG. 2, the pseudolite PRN code assigning system comprises a control center 100 and a plurality of pseudolites 210 to 250. The control center 100 stores information related to pseudolites under control of the control center 100, stores PRN codes available for a plurality of time periods, and manages pseudolite PRN codes according to the stored information. The control center 100 communicates with its pseudolites via wireless or wired connections. In the example shown in FIG. 2, PRN codes PRN #12, PRN #34, PRN #19, PRN #32, and PRN #22 are assigned respectively to the pseudolites 210, 220, 230, 240 and 250. Pseudolites 230 and 240 as shown to wirelessly communicate with the control center 100.

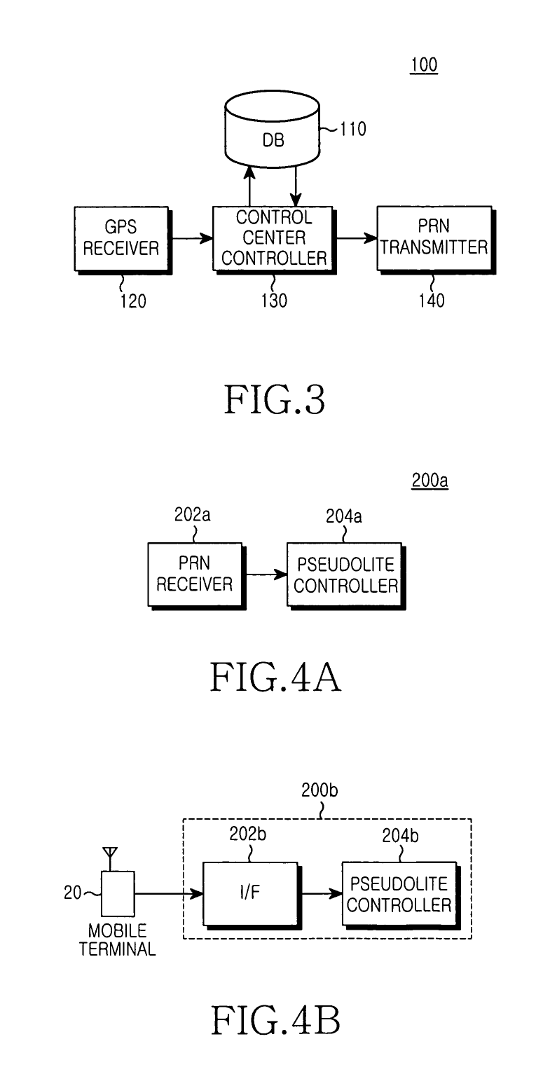

FIG. 3 is a block diagram of the control center 100 according to the embodiment of the present invention. Referring to FIG. 3, the control center 100 includes a database (DB) 110, a GPS receiver 120, a control center controller 130, and a PRN transmitter 140.

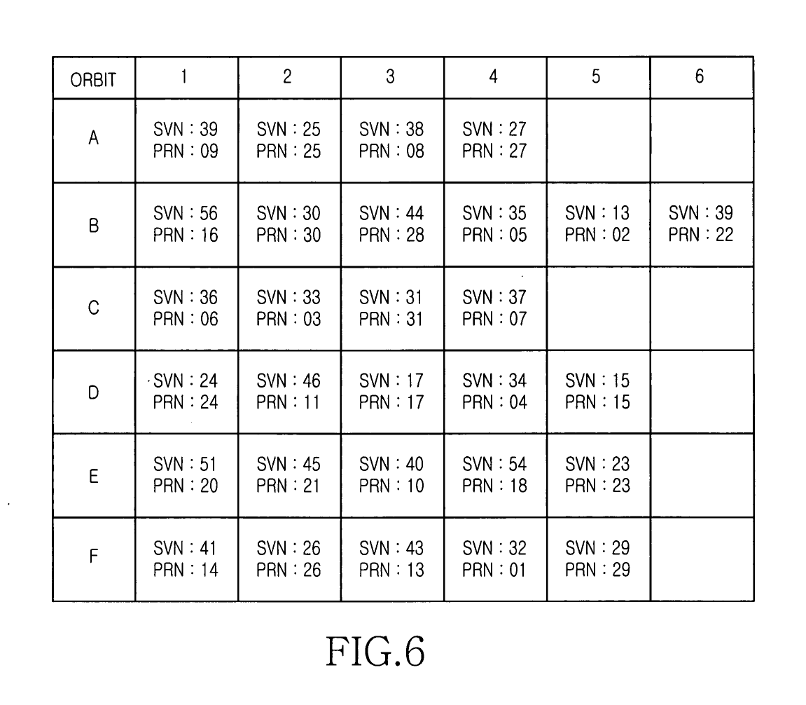

The DB 110 stores/manages the information related to pseudolites under control of the central center 100, and PRN codes available for each time period. The time periods will be described later in more detail with reference to FIGS. 6, 10, 12 and 13.

The GPS receiver 120 receives a GPS signal from a GPS satellite and synchronizes the pseudolite PRN code assigning system to the GPS satellite using the received signal.

The control center controller 130 determines PRN codes that can be assigned to the controllable pseudolites according to the information stored/managed in the DB 110. It is desirable that the determined PRN code has the best correlation with the PRN codes of GPS satellites in order to clearly distinguish from the PRN codes of the GPS satellites.

The control center controller 130 assigns different PRN codes to pseudolites within the same propagation area according to the information of the DB 110.

The PRN transmitter 140 transmits the available pseudolite PRN codes to corresponding to pseudolites. It is preferable to configure the PRN transmitter 140 to selectively support wired and wireless networks. Both a public network and a dedicated network can be used as the wired network, and a mobile communication network or a wireless LAN (Local Area Network) can be selected as the wireless network.

FIGS. 4A and 4B are schematic block diagrams of pseudolites to which PRN codes are assigned according to the embodiment of the present invention.

Referring to FIG. 4A, a pseudolite 200a has a PRN receiver 202a and a pseudolite controller 204a.

The PRN receiver 202a receives data transmitted from the control center 100 illustrated in FIG. 3 and transmits the data to the pseudolite controller 204a. The data provides information about a PRN code to be assigned to the pseudolite 200a.

The pseudolite controller 204a modulates a GPS signal with the PRN code provided from the PRN receiver 202a and transmits the modulated signal to be received by a GPS receiver.

FIG. 4B illustrates a pseudolite 200b using a typical mobile terminal 20. Referring to FIG. 4B, the pseudolite 200b includes an interface (I/F) 202b for interfacing with the mobile terminal 20 and a pseudolite controller 204b. A mobile terminal can be used as a link or repeater between a control center and a pseudolite.

The pseudolite controller 204b is similar in structure and operation to its counterpart 204a illustrated in FIG. 4A.

The I/F 202b receives PRN code information over a wireless network via the mobile terminal 20 and transmits it to the pseudolite controller 204b.

The pseudolite controller 204b then modulates a transmission signal using the PRN code information and transmits the modulated signal to by received by a GPS receiver.

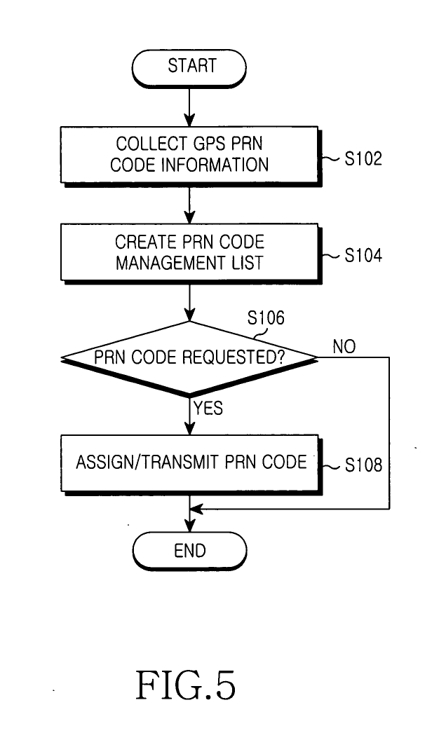

FIG. 5 is a flowchart illustrating a pseudolite PRN code assigning method according to the embodiment of the present invention. The control center 100 illustrated in FIGS. 2 and 3 is responsible for assigning PRN codes to pseudolites.

Referring to FIGS. 3 and 5, the control center 100 collects via the GPS receiver 120 the PRN codes of GPS satellites from which signals can be received in step S102. Since the GPS receiver 120 is continually operative, the control center 100 can receive GPS signals and determine the PRN codes of GPS satellites that are available at different points in time.

The control center controller 130 updates/verifies/manages a PRN code management list stored in the DB 110 according to the PRN code information in step S104. The PRN code management list manages PRN codes in current use by GPS satellites.

The control center controller 130 assigns PRN codes to pseudolites at predetermined time intervals according to the PRN code management list. That is, when a present PRN code for a particular pseudolite is to be replaced by a new PRN code in step S106, the control center controller 130 assigns the new PRN code to the pseudolite referring to the PRN code management list in step S108.

The control center controller 130 assigns PRN codes by referring to the PRN code management list in the manner that prevents a plurality of pseudolites within the same coverage area from using the same PRN code. The PRN transmitter 140 notifies the pseudolites of the assigned PRN codes.

FIG. 6 is an example of a table listing the use states of pseudolite PRN codes according to the pseudolite PRN code assigning method according to the embodiment of the present invention. Reference characters A to F denote six GPS satellite orbits, and reference numerals 1 to 6 denote slot numbers in which a GPS satellite exists in each orbit. SVN (satellite vehicle number) is a unique number identifying a GPS satellite. The SVN is increased by one each time an obsolete GPS satellite is replaced. Therefore, while PRN numbers are limited to 1 through 32, an SVN can be greater than the PRN numbers.

Referring to FIG. 6, PRN #12, PRN #19 and PRN #32 are currently unused among PRN #1 to PRN #32 assigned to the GPS satellites. This implies that PRN #12, PRN #19 and PRN #32 are available to pseudolites. Hence, the control center controller 130 can assign one of PRN #12, PRN #19 and PRN #32 to a pseudolite.

In accordance with the pseudolite PRN code assigning method depicted in FIG. 5, the control center controller 130 manages the PRN codes of a plurality of pseudolites using the PRN code management list, so that the same PRN code is not assigned to more than one pseudolite within the same coverage area. By utilizing this system, there is no lack of PRN codes for pseudolites.

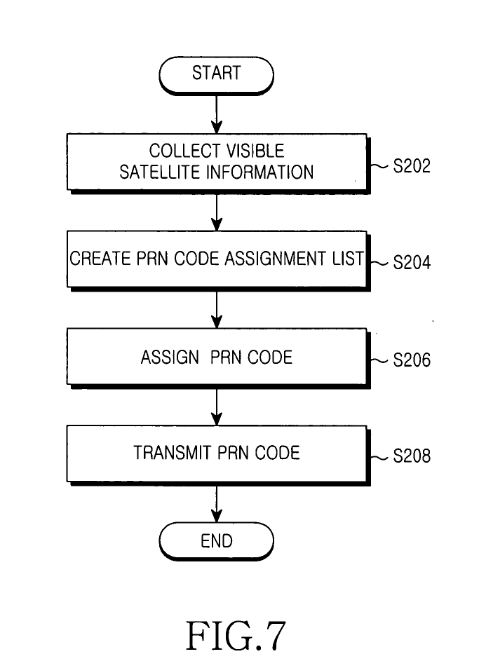

FIG. 7 is a flowchart illustrating a pseudolite PRN code assigning method according to another embodiment of the present invention. The control center controller 130 also performs this pseudolite PRN code assignment method.

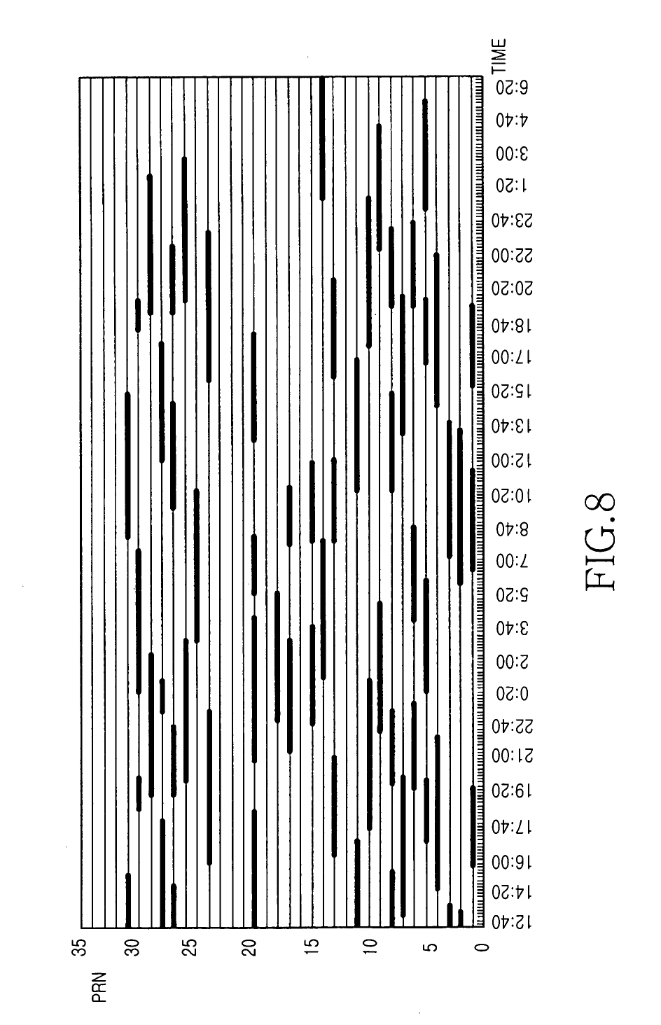

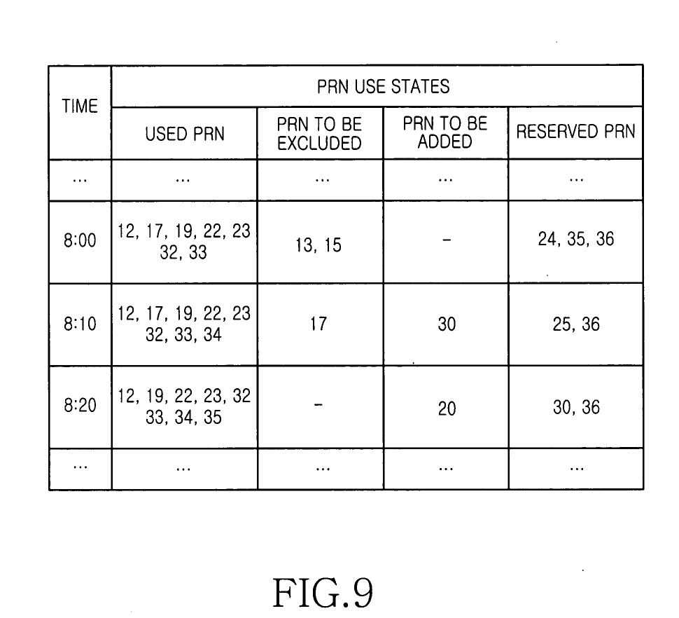

FIG. 8 is a graph illustrating the availability of visible satellites at corresponding times at a specific position, and FIG. 9 is an example of a table indicating the use states of pseudolite PRN codes at each unit time in the pseudolite PRN code assigning method according to the second embodiment of the present invention.

Referring to FIGS. 7, 8 and 9, the control center 100 collects visible satellite information for at each unit time for a predetermined observation period in step S202. For example, the control center 100 collects information relating to GPS satellites, from which signals can be received, every 10 minutes for a 24 hour period and at a predetermined observation position (e.g. the place where the GPS receiver 120 is installed). The collected GPS satellite information provides the PRN codes of the GPS satellites at each time period. An example of the visible satellite information collected on a time basis is illustrated in FIG. 8. From FIG. 8, it is noted that the visible satellite information is variable at the same position, that is, variable by time at the fixed GPS receiver position. In other words, at least one GPS satellite is observable every predetermined time period because each GPS satellite orbits the earth in a cycle of about 12 hours. According to the collected information, the control center 100 can predict when and from which GPS satellite it can receive signals, or from when it cannot receive signals from a particular GPS satellite. The control center 100 can assign pseudolites the PRN codes of GPS satellites from which the control center 100 has determined that it cannot receive signals.

The control center controller 130 creates a PRN code assignment table using the visible satellite information variable with time in step S204. That is, the control center controller 130 determines, using the collected information, the PRN codes of GPS satellites from which it cannot receive signals at the observation position of the control center 100, and at time periods when it cannot receive a GPS signal from particular GPS satellites. The control center controller 130 also generates information relating to available PRN codes for pseudolites at each unit time according to the PRN code information and the time information. The information related to available PRN codes for pseudolites at each unit time is set forth as the pseudolite PRN code assignment table.

Referring to FIG. 9, the pseudolite PRN code use state table contains PRN codes in use at each unit time, PRN codes to be excluded, added PRN codes, and reserved PRN codes. That is, the control center controller 130 manages PRN codes used at each unit time, excluded PRN codes, added PRN codes, and reserved PRN codes. In FIG. 9, the numbers of the PRN codes in use at 8:00 are 12, 17, 19, 22, 23, 32 and 33, PRN codes 13 and 15 are to be excluded, and PRN codes PRN #24, PRN #35 and PRN #36 are reserved. AT 8:10, PRN #12, PRN #17, PRN #19, PRN #22, PRN #23, PRN #32, PRN #33 and PRN #34 are occupied, PRN code 17 is to be excluded, PRN code 30 is to be added, and PRN #25 and PRN #36 are reserved. In this manner, the control center controller 130 creates a PRN code assignment table based on the pseudolite PRN code use states.

For example, the control center controller 130 creates a PRN code assignment table and can assign a pseudolites a PRN as follows: one of PRN #24, 35 and 36 is assigned at 8:00, one of PRN #25 and 36 is assigned at 8:10, and one of PRN #30 and PRN #36 is assigned at 8:20, according to the information illustrated in FIG. 9.

The control center controller 130 assigns PRN codes to pseudolites which are under control of the control center 100 according to the pseudolite PRN code assignment table in step S206 and notifies the pseudolites of the PRN codes through the PRN transmitter 140 in step S208.

In this case, a variable PRN code is assigned to each pseudolite. That is, a different PRN code can be assigned to the pseudolite at each unit time under the control of the control center controller 130 according to the pseudolite PRN code assignment table.

The PRN code assigning method depicted in FIG. 7 also solves the problem of using the same PRN code for a plurality of pseudolites within the same coverage area and avoids a lack of PRN codes available pseudolites by managing the PRN codes of the pseudolites by time in the PRN code assignment table.

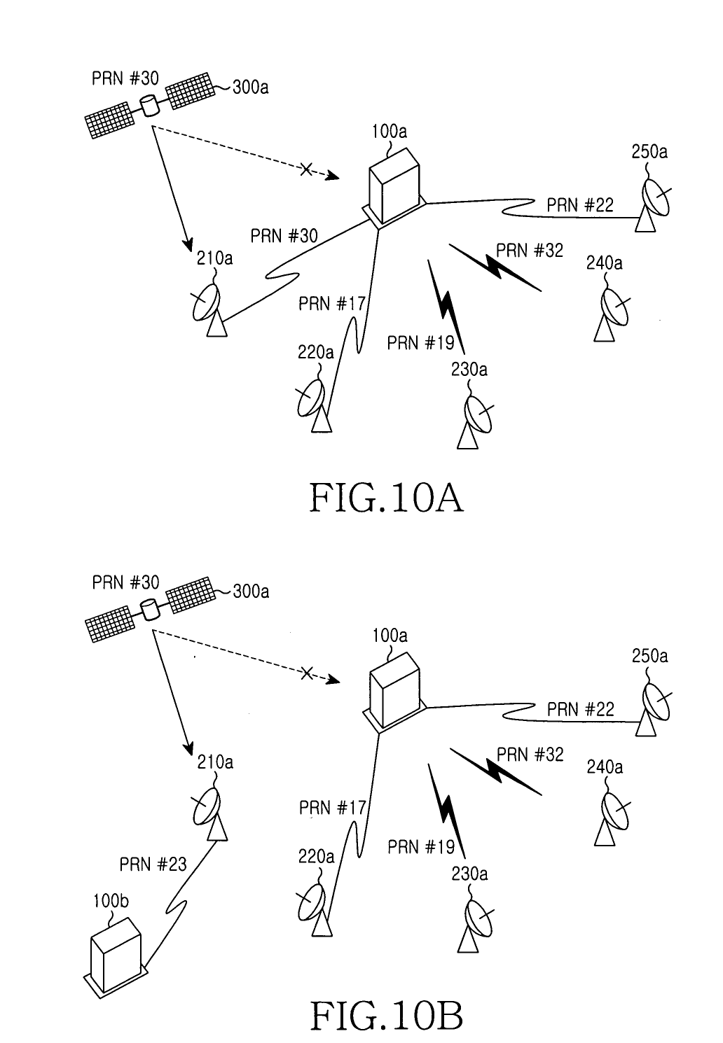

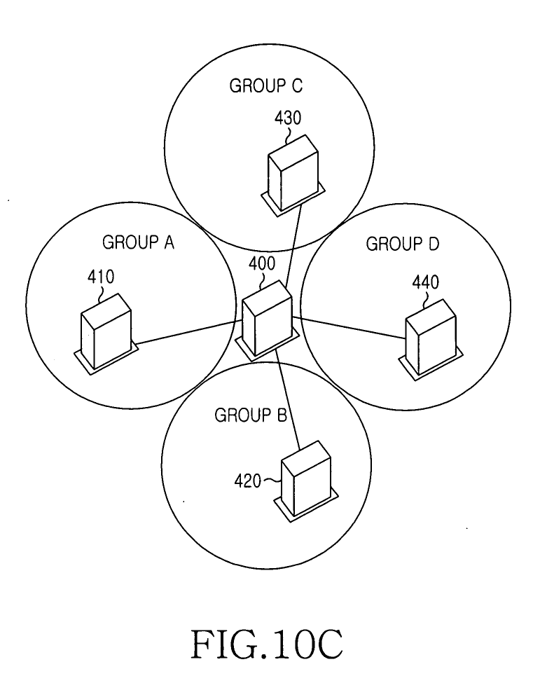

FIGS. 10A, 10B and 10C illustrate an example grouping of a plurality of pseudolites for PRN code management.

Referring to FIG. 10A, when control center 100a is far from its controlled pseudolites, the control center 100a and the pseudolites can observe different GPS satellites. For Example, the control center 100a, shown in FIG. 10A, cannot receive a signal from a GPS satellite 300a, eventhough some of pseudolites 210a to 250a under the control of the control center 100a (e.g., a pseudolite 210a) may be able to receive signals from the GPS satellite 300a. This is because the control center 100a is far away from the pseudolite 210a. In this case, since the control center 100a cannot receive a signal from the GPS satellite 300a, it may consider that the PRN code, PRN #30 of the GPS satellite 300a is available for a pseudolite.

In this situation the control center 100a might assign the PRN code, PRN #30, of the GPS satellite 300a, to the pseudolite 210a, and the pseudolite 210a would then transmit a signal with the PRN code, PRN #30. Therefore, GPS receivers within the coverage area of the pseudolite 210a and GPS satellite 300a receive signals modulated with the same PRN code, PRN #30 from different satellites GPS satellite 300a and pseudolite 210a, making it impossible to accurately calculate the positions of the GPS receivers.

It is, therefore, preferable in an embodiment of the present invention to install the control center 100a in a coverage area to observe the same GPS satellite 300a as the pseudolites 210a to 250a. It is also preferable to install a plurality of control centers in a wide area with different PRN codes assigned to pseudolites under the control of each of the control centers.

FIG. 10B includes a second control center 100b for managing pseudolite 210a to solve the problem encountered with the pseudolite grouping illustrated in FIG. 10A. Referring to FIG. 10B, control center 100a manages only pseudolites 220a to 250a and control center 100b manages pseudolite 210a, which is located far from control center 100a. Therefore, the problem that GPS receivers within the coverage area of the pseudolite 210a receive signals modulated with the same PRN code from different satellites (i.e. a GPS satellite and a pseudolite) is solved.

FIG. 10C illustrates an exemplary application of the pseudolite grouping illustrated in FIG. 10B, in which one control center 400 can control a plurality of virtual control centers 410 to 440. When pseudolites are deployed over a wide area, a plurality of groups are defined, each having the same GPS observations and one control center. Referring to FIG. 10C, the pseudolite PRN code assigning system of the present invention divides a wide area into four groups (e.g., group A, group B, group C and group D) and control centers 410 to 440 are installed in the respective groups. Although it is preferable to install an individual control center for each group, it is possible to concentrate all functions on one control center (e.g., 400) and the other control centers (e.g. 410 to 450) are configured as virtual control centers in order to reduce problems possibly generated when too many control centers operate in one coverage area.

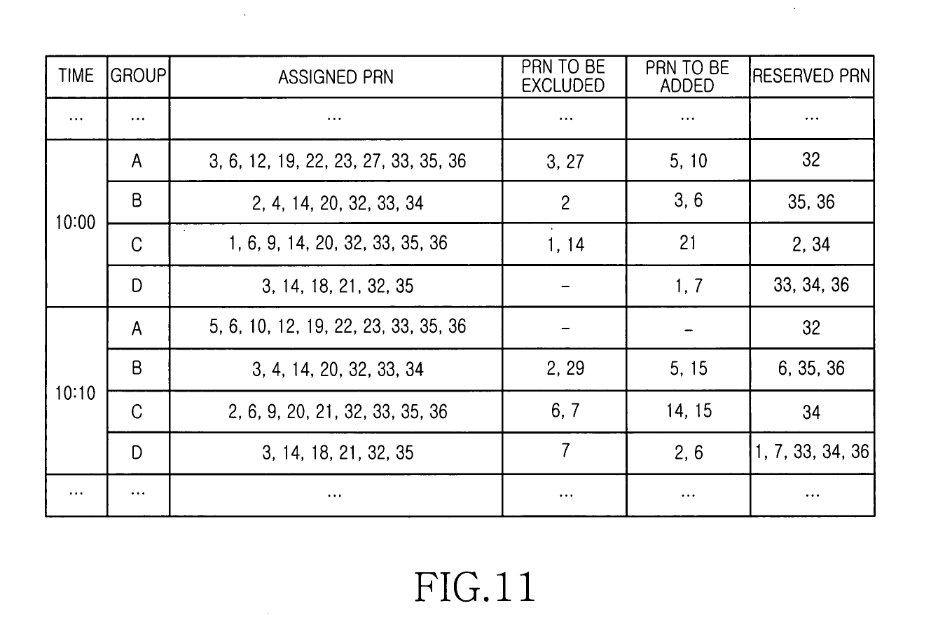

FIG. 11 illustrates a table listing the use states of pseudolite PRN codes by time/group in a pseudolite PRN code assigning method according to a third embodiment of the present invention. This PRN code use state list provides information related to the use states of the PRN codes of observable GPS satellites for respective areas as illustrated in FIG. 10C. Referring to FIG. 11, for each unit time, PRN code numbers assigned to each group, PRN code numbers to be deleted, PRN code numbers to be added for pseudolites, and PRN codes that are available to pseudolites but not actually assigned are managed by group. The use states of pseudolite PRN codes are represented every 10 minutes in FIG. 11, but the time interval can be changed when needed.

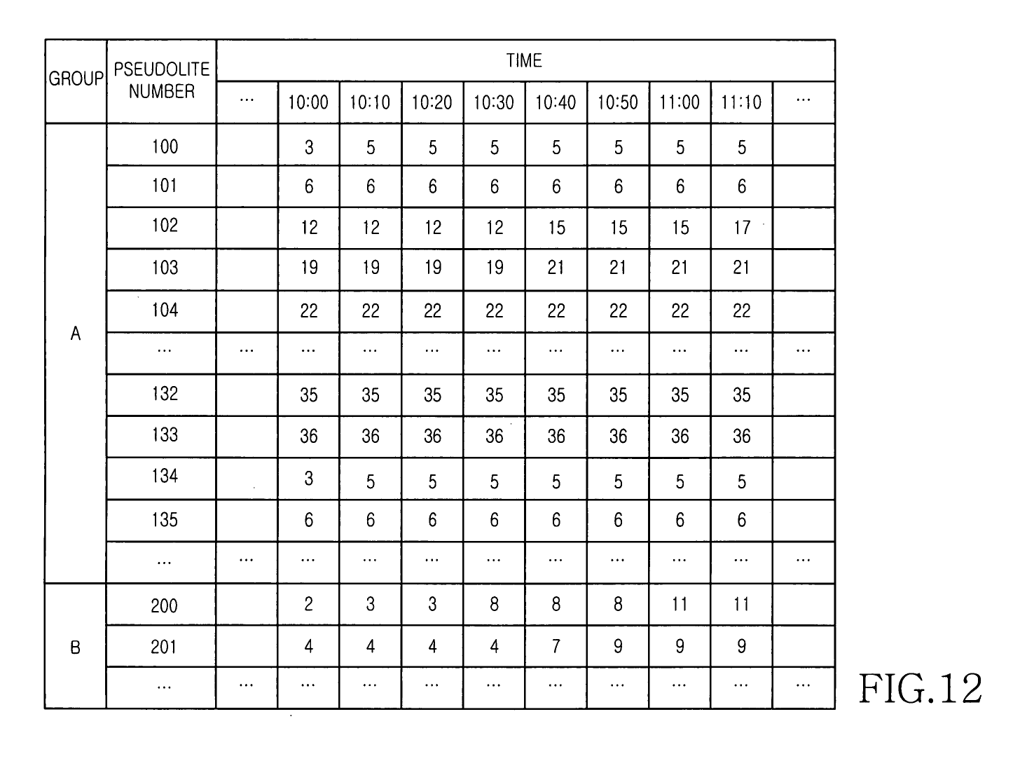

FIG. 12 illustrates a table listing assigned pseudolite PRN codes by time/group in the pseudolite PRN code assigning method according to the third embodiment of the present invention. The control center 400 illustrated in FIG. 10C creates a PRN code assignment list for managing the PRN codes of pseudolites by time referring to the time/group-based pseudolite PRN code use state list illustrated in FIG. 11. When assigning PRN codes to pseudolites, the control center 400 controls pseudolites at the boundary of each group A, B, C or D so that the boundary pseudolites not to use the same PRN code as an adjacent pseudolites. PRN codes are assigned to pseudolites every ten minutes in FIG. 12, but the time interval can be changed when needed.

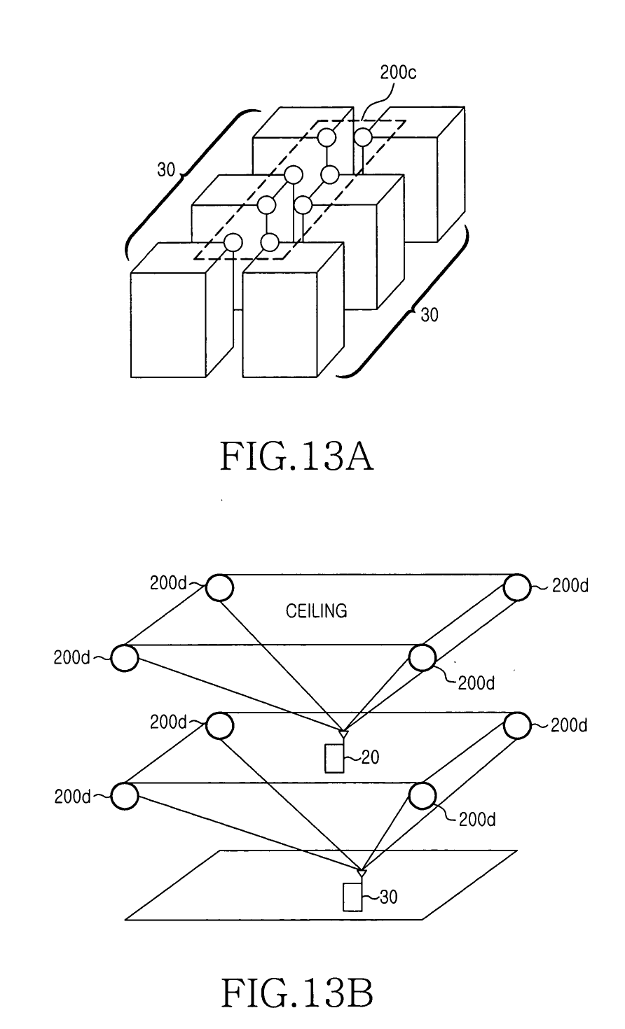

FIGS. 13A and 13B illustrate arrays of pseudolites according to the present invention. FIG. 13A illustrates deployment of pseudolites in a dense urban area with tall buildings. Referring to FIG. 13A, pseudolites 200c are installed at corners of blocks 30 separated from one another by roads. FIG. 13B illustrates indoor deployment of pseudolites. Referring to FIG. 13B, pseudolites 200d are installed at the corners of the ceiling on each floor of a building. Particularly, since the pseudolites 200d are positioned within the same coverage area, different PRN codes must be assigned to them.

In accordance with the present invention as described above, a control center manages the PRN codes of pseudolites so that a plurality of pseudolites within the same coverage area do not use the same PRN code. The assignment of the PRN codes of in available GPS satellites prevents a lack of PRN codes for pseudolites.

While the invention has been shown and described with reference to certain preferred embodiments thereof, it will be understood by those skilled in the art that various changes in form and details may be made therein without departing from the spirit and scope of the invention as defined by the appended claims.

1. A method of assigning pseudo random noise (PRN) codes to pseudolites by a management server having a GPS (Global Positioning System) receiver and managing the PRN codes of pseudolites within a predetermined range, the method comprising the steps of:
collecting PRN codes of GPS satellites;
verifying and updating a PRN code management list using the collected PRN codes;
determining a PRN code to assigned to a pseudolite based on the PRN code management list; and
notifying the pseudolite of the determined PRN code.

2. The method of claim 1, wherein the step of verifying and updating the PRN code management list comprises the steps of:
detecting PRN codes currently in use by pseudolites and GPS satellites; and
verifying and updating the PRN code management list to include information about PRN codes currently used by GPS satellites.

3. The method of claim 1, wherein a PRN code most correlated with the PRN code of a GPS satellite is assigned to the pseudolite in the PRN code determining step.

4. The method of claim 1, wherein different PRN codes are assigned to pseudolites within the same coverage area.

5. The method of claim 1, wherein information indicating the determined PRN code is transmitted to the pseudolite via a wired communication network or a wireless network.

6. A method of assigning pseudo random noise (PRN) codes to pseudolites by a management server having a GPS (Global Positioning System) receiver and managing the PRN codes of pseudolites within a predetermined range, the method comprising the steps of:
collecting visible GPS satellite information for predetermined units of time for a predetermined observation period;
generating a time-based pseudolite PRN code assignment table using the collected visible GPS satellite information;
determining PRN codes to assign to the pseudolites based on the PRN code assignment list; and
notifying the pseudolites of the determined PRN codes.

7. The method of claim 6, wherein the PRN code numbers of visible GPS satellites are collected using GPS signals received through the GPS receiver each unit of time for a predetermined observation time period at a predetermined observation position.

8. The method of claim 6, wherein generating to the PRN code assignment list, comprises the steps of:
determining the visible period of each GPS satellite at the observation position using the collected visible satellite information;
detecting unit times when GPS signals cannot be received from each of the GPS satellite using the visible period of the GPS satellite; and
determining the PRN codes of GPS satellites from which GPS signals cannot be received to be PRN codes available to pseudolites at the respective unit times.

9. The method of claim 6, wherein the PRN code determining step comprises the steps of:
determining if the present time is within the visible time period of a GPS satellite corresponding to the assigned PRN code of a pseudolite according to the PRN code assignment table; and
changing the PRN code of the pseudolite if the present time is within the visible time period of the GPS satellite.

10. The method of claim 6, wherein PRN codes most correlated with the PRN codes of the GPS satellites are assigned to the pseudolites in the PRN code determining step.

11. The method of claim 6, wherein different PRN codes are assigned to pseudolites within the same coverage area.

12. A system for assigning pseudo random noise (PRN) codes to pseudolites, comprising:
a management server for collecting information related to PRN codes of GPS (Global Positioning System) satellites; and
a plurality of pseudolites for modulating transmission signals with PRN codes assigned from the management server.

13. The system of claim 12, wherein the management server comprises:
a GPS receiver for receiving GPS signals from GPS satellites;
a storage unit for storing and managing information related to the pseudolites and information related to PRN codes available for different units of time;
a controller for determining PRN codes available to the pseudolites according to the stored information and notifying the pseudolites of the PRN codes; and
a transmitter for transmitting information indicating the PRN codes to the pseudolites under the control of the controller.

14. The system of claim 13, wherein the controller detects PRN codes most correlated with the PRN codes of the GPS satellites as available to the pseudolites.

15. The system of claim 13, wherein the controller assigns different PRN codes to pseudolites within the same coverage area.

16. The system of claim 13, wherein the transmitter transmits the information indicating the PRN codes to the pseudolites via a wired network or a wireless network.

17. The system of claim 12, wherein each of the pseudolites comprises:
a PRN receiver for receiving information indicating an assigned PRN code from the management server; and
a pseudolite controller for modulating a transmission signal using the PRN code and transmitting the modulated signal.

18. The system of claim 17, wherein the PRN receiver is connected to the management server and receives the information indicating the assigned PRN code form the management server.

19. The system of claim 19, wherein the PRN receiver is a wireless interface for transmitting and receiving data to and from a mobile terminal, and receives the information related to the assigned PRN code from the management server through the mobile terminal.

20. A system for assigning pseudo random noise (PRN) codes to pseudolites, comprising:
a plurality of management servers, each for collecting information related to PRN codes of GPS (Global Positioning System) satellites and managing the PRN codes of pseudolites within a predetermined range based on the collected PRN code information;
an integrated server for managing the management servers; and
a plurality of pseudolites, each being positioned in the coverage area of one of the management servers, for modulating a transmission signal with a PRN code assigned from the management server.
